(19) United States
(12) Patent Application Publication
(10) Pub. No.: US 2015/0148916 A1
(43) Pub. Date: May 28, 2015

(54) CONTROL DEVICE ABLE TO CONNECT TO A COMMUNICATION NETWORK LINKING A CONTROL INTERFACE AND AN EQUIPMENT

(71) Applicant: Schneider Electric Industries SAS, Rueil Malmaison (FR)

(72) Inventor: Thierry CHICHE, Saint Ismier (FR)

(73) Assignee: Schneider Electric Industries SAS, Rueil Malmaison (FR)

(21) Appl. No.: 14/535,493

(22) Filed: Nov. 7, 2014

(30) Foreign Application Priority Data
Nov. 22, 2013 (FR) 13 61505

(51) Int. Cl. G05B 15/02

(52) U.S. Cl. CPC G05B 15/02
USPC 700/17; 700/11

(57) ABSTRACT

The invention relates to a control device (3) intended to be connected to a communication network (R) over which frames exchanged between an automation equipment item (2) and a control interface (1) of said equipment item circulate, said device comprising:
A recording module (36) arranged to control a recording of at least one frame transmitted by the control interface (1) to the automation equipment item (2), an action being associated with said stored frame,
A control module (37) arranged to:
   retransmit said stored frame (T1-Tn) to the automation equipment item (2) when said action (A1-An) is controlled,
   queue and store all the frames exchanged between the control interface (1) and the automation equipment item (2) during the execution of said action,
   return, after the end of the execution of said action (A1-An), all the frames queued during the execution of said action.

### TECHNICAL FIELD OF THE INVENTION

The present invention relates to a control device intended to be connected to a communication network linking a control interface to an equipment item to be controlled by said control interface.

### STATE OF THE ART

In the industrial, field, it is known practice to employ a control interface of graphical type to control one or more equipment items such as, for example, automation equipment items. The control interface has functions that make it possible to receive and view the state of each controlled equipment item, send commands to modify their operating mode, to stop or start each equipment item.

When it is of graphical type, the functions available for the operator are distributed over several pages to be scrolled. For some operations, the operator must therefore navigate through a plurality of menus to select the desired functions and send the corresponding control signals over the communication network, to the controlled equipment items.

For simple operations, for example starting, placing on standby or stopping, the navigation in the various menus of the control interface can prove lengthy and tedious. Moreover, if one and the same interface is dedicated to the control of a plurality of distinct equipment items, some options will have to be performed several times for each of the controlled equipment items.

A solution is known from the patent DE102007048250 in which an automation equipment item is capable of creating a queue of frames to be sent to a machine.

The aim of the invention is to propose a control device which enables an operator to avoid a lengthy and tedious navigation through the menus of a control interface, notably of graphical type, and control each equipment item or a plurality of equipment items both simply and rapidly.

### EXPLANATION OF THE INVENTION

This aim is achieved by a control device intended to be connected to a communication network over which frames exchanged between an automation equipment item to be controlled and a control interface connected to said automation equipment item through said communication network circulate, said device being arranged to replace said control interface and comprising:
a recording module arranged to store at least one frame transmitted by the control interface and received by the automation equipment item, an action being associated with said stored frame,
a control module arranged to retransmit said stored frame to the automation equipment item when said action is controlled,
a control member arranged to control said action,
the control module being arranged to queue and store all the frames exchanged between the control interface and the automation equipment item during the execution of said action,
The control module being arranged to resend, after the end of the execution of said action, all the frames queued during the execution of said action.

According to a particular feature, the device comprises a first network interface intended to be connected to the control interface and a second network interface intended to be connected to the automation equipment item.

According to another particular feature, the device comprises an intelligent switch arranged to manage each frame circulating over the communication network originating from the control interface or from the automation equipment item.

According to another particular feature, the device comprises a communication network type detection and self-configuration module for communicating over said communication network.

According to another particular feature, the device comprises a network analyzer controlled by the recording module and arranged to store said at least one frame.

According to another particular feature, the device is arranged to operate according to one of the following three modes: recording mode, control mode and normal mode.

According to another particular feature, the device comprises a human-machine interface, that can be actuated by an operator, a transmitter coupled to a receiver or a logic system executing said action by taking account of the value taken by one or more determined parameters.

### BRIEF DESCRIPTION OF THE FIGURES

Other features and advantages will emerge from the following detailed description, given in light of the attached drawings in which:

FIG. 1 schematically represents the control device of the invention and its position in an automation architecture.

### DETAILED DESCRIPTION OF AT LEAST ONE EMBODIMENT

The invention is applicable notably to an automation architecture in which a control interface 1, preferably of graphical type, controls one or more equipment items 2, preferentially automation equipment items, through a communication network R. The communication network is, for example, of Ethernet or Modbus type or another known solution. The communication network R is preferably of wired type.

Automation equipment item 2 should be understood for example to mean at least one programmable logic controller, at least one variable speed drive or any other control solution of an industrial application or process.

Control interface 1 should be understood to mean any system that makes it possible to control an equipment item. It can therefore be a set of buttons, a touch screen or any combination between these different elements.

Data are exchanged over the communication network R between a control interface 1 and an equipment item 2 in the form of one or more frames. A frame corresponds, for example, to a command sent by the control interface 1 to the equipment item 2 or to information returned by the equipment item 2 to the control interface 1, for example status or diagnostic information.

The invention relates to a control device 3 intended to be connected to the communication network R linking the control interface 1 to the controlled equipment item 2.

This control device 3 will be able, for example, to be inserted into the existing automation architecture in order to monitor and record the traffic on the communication network R. In one embodiment, the frames exchanged between the control interface 1 and the equipment item 2 will be captured by the control device 3. The operator will be able, notably, to select one or more captured frames T1-Tn and associate them with an action A1-An. The control device 3 is then arranged to make it possible to send the frames T1-Tn associated with the duly defined actions A1-An.

The control device 3 will be able, for example, to take the form of a simplified human-machine interface made up of one or more buttons physically connected to the network.

The control device 3 of the invention comprises communication means for communicating over the communication network R with the control interface 1 and the equipment item 2. It also comprises processing means UC notably comprising a microprocessor μP and storage means M. The processing means UC are arranged to operate the control device according to the different modes described above.

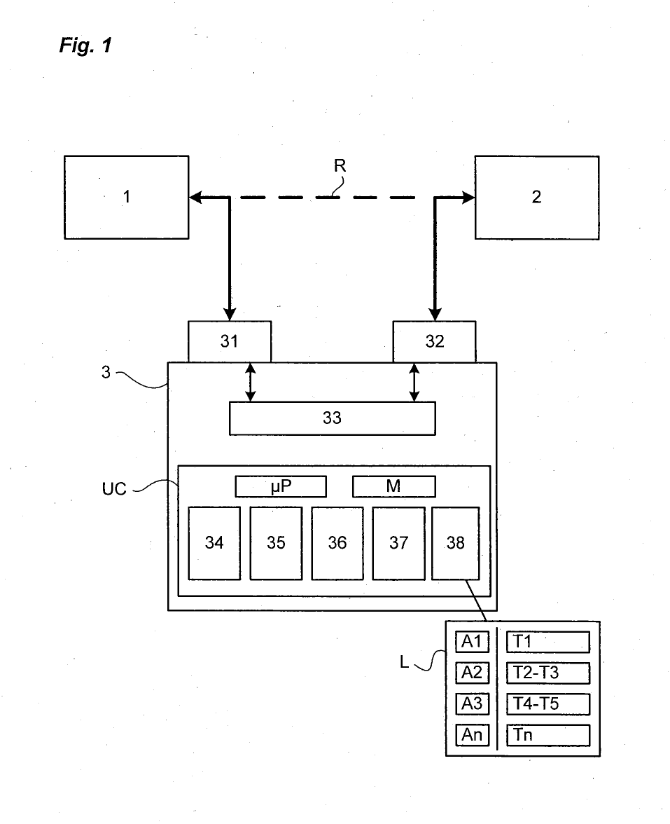

More functionally and with reference to FIG. 1, the communication means of the control device of the invention more specifically comprise:
A first network interface 31 and a second network interface 32. The control device 3 is connected to the communication network R so as to be linked by its first network interface 31 to the control interface 1 and by its second network interface 32 to the equipment item 2.
An intelligent switch 33 linked both to the first network interface 31 and to the second network interface 32.

The processing means UC of the control device 3 comprise, for their part:
A communication network R type detection and self-configuration module 34 for connecting to this network R.
A network analyzer 35.
A recording module 36.
A control module 37.
A module 38 for generating a list L of the actions programmed by the operator and of the selected frames T1-Tn associated with each action A1-An.

Using these different components, the control device 3 operates according to three distinct operating modes:
A normal mode.
A recording mode.
A control mode.

The normal mode is the mode of operation in which the control device 3 is not involved. In normal mode, all the frames detected on a network interface are routed automatically by the intelligent switch 33 to the other network interface so as not to disturb the exchanges between the control interface 1 and the equipment item 2.

The recording mode is the mode of operation in which the frames normally exchanged between the control interface 1 and the equipment item 2 are recorded by the control device 3. The recording mode will be able to be of several types.

A first type of the recording mode consists in directly loading into the control device frames exchanged between the control interface 1 and the equipment item 2 in the control device, these frames being previously known, by detection using a network analyzer or another means. The action associated with each of the frames loaded in the control device 3 will be able to be selected previously and loaded together with the frames or selected in situ on the control device. This mode of operation offers the advantage of being reliable and inexpensive because the detection and the selection of the relevant frames is performed upstream, using a simple computer.

A second type of the recording mode assigned to the control device consists of a learning mode provided with a plurality of distinct phases:
A capture phase in which the control device 3 stores the frames exchanged over the communication network R between the control interface 1 and the equipment item 2.
A selection phase in which the operator defines an action A1-An and selects the captured frame or frames T1-Tn to be associated with this action.
A recording phase implemented by the generation module 38 and in which the selected frames T1-Tn are stored in the storage means in the form of the list L, in association with the actions A1-An defined by the operator.

The control mode can be implemented only if the recording mode is terminated. In the control mode, the control device 3 is suitable for applying at least one of the actions A1-An defined during the recording mode and for transmitting the frames T1-Tn which correspond to this action. The control of execution of the action can originate, for example:
from a human-machine interface associated with the device 3, such as, for example, a push button, actuated by the operator, or
from a transmitter coupled to a receiver associated with the device, or from a logic system sending the execution control by taking into account certain criteria, such as, for example, the value taken by one or more parameters (time band, temperature, etc.).

In the control mode, in order to transmit the frame or frames associated with the controlled action without generating disturbances, all the frames detected on one or other of the two network interfaces 31, 32 are temporarily stored in the storage means

M in order to be retransmitted once the sequence of transmission of the frame or frames associated with the controlled action is terminated. These stored frames are retransmitted in the order of their reception.

The components described above operate as follows in the different modes of operation defined above:

1) Intelligent Switch
In normal mode, it is arranged to automatically route all the frames detected on one network interface to the other network interface so as not to disturb the normal communication established between the control interface 1 and the equipment item 2.
In control mode, the intelligent switch 33 operates by following a number of successive steps:
   A waiting step during which the intelligent switch 33 waits for the end of exchanges of data between the control interface 1 and the equipment item 2.
   A step of transmission of the frame or frames T1-Tn which correspond to the action A1-An requested by the operator.
   A step of temporary recording in the storage means M of all the frames detected on the first network interface 31 and on the second network interface 32 during the transmission of the frame or frames which correspond(s) to the action controlled by the operator.
   A step of retransmission of the frames stored during the preceding step.

2) Communication Network Type Detection and Self-Configuration Module for Connecting to this Network

This software detection module 34 is arranged to determine the type of communication network R to which the device 3 is connected and to determine the parameters necessary for the device 3 to be able to communicate over said communication network R with a view to storing them in its storage means M. If the communication network R is of Ethernet type, the module then has to detect the IP (“Internet Protocol”) parameters, notably the IP addresses of the control interface 1 and of the equipment item 2 and appropriate them each time a frame is sent in the control mode. If the communication network R is implemented on a field bus, for example of Modbus type, the module detects the configuration of the communication parameters.

This detection module is optional and the type of network and network parameters could be input directly on the control device 3.

3) Network Analyzer
In the recording mode of second type described above:
   The network analyzer 35 is arranged to store in the storage means M all the frames detected on each network interface 31, 32.
   The network analyzer 35 determines the network address of the control interface 1 in order to be able to replace it during the execution of an action.
In normal mode, the network analyzer 35 is not involved.
In control mode:
   The network analyzer 35 is arranged to detect the end of the exchanges of data between the two network interfaces 31, 32.
   The network analyzer 35 is arranged to start the temporary recording in the storage means M of the frames detected on the first network interface 31 or on the second network interface 32 during the execution of an action A1-An defined by the operator.

4) Recording Mode

This is involved only after activation of the recording mode and it works differently depending on the recording mode selected.

In operation in recording mode of the first type, it manages the recording of the frames in the storage means.

In operation in recording mode of the second type, it operates by executing the following steps:
Step 1: It is arranged to control the start of the recording of the frames detected by the network analyzer 35 on the first network interface 31, that is to say the frames originating from the control interface 1.
Step 2: It is arranged to control the stopping of the recording of the frames.
Step 3: The recording module 36 is arranged to play back the stored frames and ask the operator to validate or not validate the recording of each frame in the storage means M.
Step 4: The recording module 36 is arranged to prompt the operator to associate an action A1-An with one or more of the frames T1-Tn stored in the storage means M.

5) Control Module

The control module 37 is activated on the device 3 when the control mode is activated by the operator. It can be used only if the recording mode has been concluded. It is arranged to:
Detect the end of the exchanges of frames between the two network interfaces 31, 32 of the device when the device 3 is in normal mode.
Transmit the frame or frames T1-Tn associated with the action A1-An selected by the operator from the control device 3, by taking the identifier of the control interface 1, in order to convince the equipment item 2 that the action originates from the control interface 1.
Start the temporary recording of the frames detected on each network interface 31, 32 when the action A1-An has been controlled in order not to disturb the communication.
Once the frame or frames T1-Tn corresponding to the controlled action A1-An have been transmitted, transmit all the frames temporarily stored during the processing of the controlled action.
Deactivate the control mode.

6) Module for Generating the List of the Actions Programmed by the Operator and of the Selected Frames Associated with Each Action

This module 38 is arranged to generate the list of the actions A1-An programmed by the operator when in the recording mode, in association with the frames T1-Tn selected for each programmed action. This module 38 is arranged to add to this list with each new action defined by the operator.

The device of the invention therefore makes it possible to simulate an action which would normally be controlled from the control interface 1. It can thus act on the equipment item 2 in parallel with the control interface 1 and replace it for certain actions. The control device 3 of the invention operates very simply. It generates no disturbance on the communications between the control interface 1 and the equipment item 2.

It will make it possible to remotely or locally control the operating modes of the equipment items. Commands will be able to be sent manually or automatically, for example by using a programmed clock. A supervisor will also be able to be employed to control a number of control devices in parallel, the supervisor sending commands to each device, by manual or automatic control.

Moreover, the control device 3 is, for example, employed to reduce the total electrical consumption of a factory by centralizing in a single control device 3 the control of a plurality of equipment items 2 distributed around the factory and normally each controlled by a distinct control interface 1. It will thus be possible to easily control said equipment items, notably switching them to standby, from a single device.

1. Control device (3) intended to be connected to a communication network (R) over which frames exchanged between an automation equipment item (2) to be controlled and a control interface (1) connected to said automation equipment item (2) through said communication network circulate, said device being characterized in that it is arranged to replace said control interface and in that it comprises:
A recording module (36) arranged to store at least one frame transmitted by the control interface (1) and received by the automation equipment item (2), an action being associated with said stored frame,
A control module (37) arranged to retransmit said stored frame (T1-Tn) to the automation equipment item (2) when said action (A1-An) is controlled,
A control member arranged to control said action (A1-An), and in that
The control module (37) is arranged to queue and store all the frames exchanged between the control interface (1) and the automation equipment item (2) during the execution of said action,
The control module (37) is arranged to resend, after the end of the execution of said action (A1-An), all the frames queued during the execution of said action.

2. Device according to claim 1, characterized in that it comprises a first network interface (31) intended to be connected to the control interface (1) and a second network interface (32) intended to be connected to the automation equipment item (2).

3. Device according to claim 2, characterized in that it comprises an intelligent switch (33) arranged to manage each frame circulating over the communication network (R) originating from the control interface (1) or from the automation equipment item (2).

4. Device according to claim 1, characterized in that it comprises a communication network type detection and self-configuration module (34) for communicating over said communication network (R).

5. Device according to claim 1, characterized in that it comprises a network analyzer (35) controlled by the recording module (36) and arranged to store said at least one frame.

6. Device according to claim 1, characterized in that it is arranged to operate according to one of the following three modes:
recording mode, control mode and normal mode.

7. Control device according to claim 1, characterized in that it comprises a human-machine interface, that can be actuated by an operator, a transmitter coupled to a receiver or a logic system executing said action (A1-An) by taking account of the value taken by one or more determined parameters.
